(19) United States
(12) Patent Application Publication
(10) Pub. No.: US 2013/0134639 A1
(43) Pub. Date: May 30, 2013

(54) SHOCKPROOF DEVICE FOR CONTAINER DATA CENTERS AND METHOD FOR USING THE SAME

(71) Applicant: WEN-JEN WU, Tu-Cheng (TW)

(72) Inventor: WEN-JEN WU, Tu-Cheng (TW)

(73) Assignee: HON HAI PRECISION INDUSTRY CO., LTD., Tu-Cheng (TW)

(21) Appl. No.: 13/415,851

(22) Filed: Mar. 9, 2012

(30) Foreign Application Priority Data
Nov. 30, 2011 (TW) 100143928

(51) Int. Cl. F16F 7/00; F16F 5/00

(52) U.S. Cl. 267/113

(57) ABSTRACT

A shockproof device for a container data center (CDC) includes an impact detection module and a shockproof module. The impact detection module is received in or attached on the CDC and detects an impact force of the CDC. The shockproof module is electrically connected to the impact detection module and includes a plurality of pressure pipes, and each of the pressure pipes having a distal end mounted on the CDC. The shockproof module generates a predetermined pressure using each of the pressure pipes according to the impact force, and the pressure is transmitted to the distal ends of the pressure pipes and forms a resisting force to counteract the impact force.

### BACKGROUND

1. Technical Field

The present disclosure relates to protection devices for container data centers (CDCs), and particularly to a shockproof device for CDCs and a method for using the same.

2. Description of Related Art

Many container data centers (CDCs) employ shockproof devices configured for protecting electronic devices received in the CDCs from outside shocks. These shockproof devices are generally springs that are mounted underneath the CDCs to support the CDCs. However, if a CDC encounters a strenuous impact force, or if a total weight of the CDC exceeds greatest load-bearing values of the springs supporting the CDC, the springs may be damaged. Furthermore, if a CDC encounters impact forces having frequencies that are equal to or approximately equal to resonance frequencies of the springs, the springs may resonate in response to the impact forces, and may further cause serious damage of electronic devices received in the CDC.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a block diagram of a shockproof device, according to an exemplary embodiment.

FIG. 2 is a schematic diagram of a shockproof module of the shockproof device shown in FIG. 1.

FIG. 3 is a flowchart of a method for using the shockproof device shown in FIG. 1, according to an exemplary embodiment.

FIG. 4 is a flowchart of a step S3 of the method shown in FIG. 3.

### DETAILED DESCRIPTION

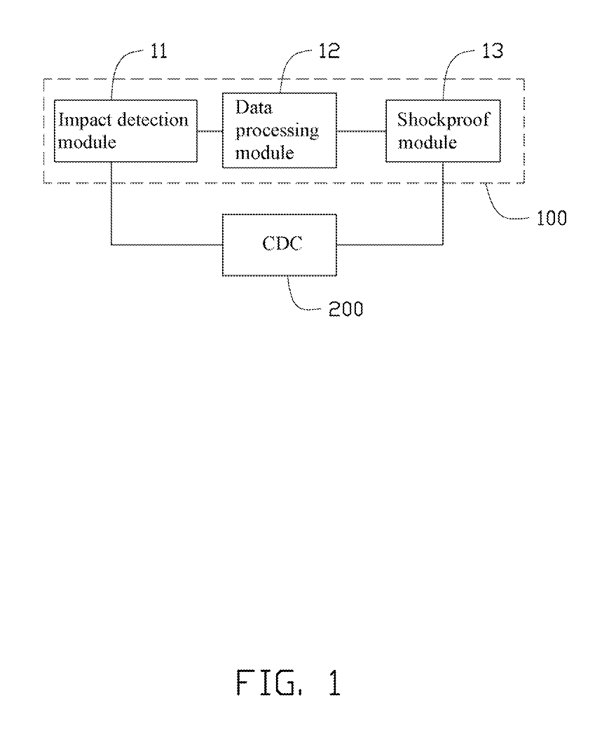

FIG. 1 shows a shockproof device 100, according to an exemplary embodiment. The shockproof device 100 can be configured on a container data center (CDC) 200 to protect the CDC 200 from shocks. The shockproof device 100 includes an impact detection module 11, a data processing module 12, and a shockproof module 13. Each of the impact detection module 11, the data processing module 12, and the shockproof module 13 includes both hardware (e.g., machineries, circuits, storage mediums, etc.) and software instructions embodied therein, and the hardware can perform predetermined functions (e.g., mechanical and/or electrical actions) in response to executing the software instructions embodied therein.

In one example, the impact detection module 11 may be a gyroscope. According to inherent characteristics of gyroscopes, the impact detection module 11 can detect movements of the CDC 200, and further detects impact forces encountered by the CDC 200 according to the movements of the CDC 200. The impact detection module 11 is received in or attached on the CDC 200 to detect impact forces encountered by the CDC 200. When the CDC 200 encounters an impact force, for example, when an earthquake or a storm happens, the impact detection module 11 detects a movement of the CDC 200 caused by the impact force, and further calculates relevant parameters of the impact force (e.g., a strength, a direction, and a duration of the impact force) according to relevant parameters of the movement (e.g., a direction, a speed, and moving time). According to the relevant parameters of the impact force, the impact detection module 11 generates an impact detection signal corresponding to the impact force. The impact detection signal is an electronic signal, which comprises data of the relevant parameters of the impact force.

The data processing module 12 can be a personal computer (PC), a single-chip computer, or other data processing devices. The data processing module 12 is positioned at a predetermined detection location and is electrically connected to the impact detection module 11 and the shockproof module 13. The data processing module 12 receives the impact detection signal from the impact detection module 11, and generates a control signal corresponding to the impact force. The control signal is sent to the shockproof module 13. Upon receiving the control signal, the shockproof module 13 can generate resisting forces corresponding to the impact force, and disposes the resisting forces on the CDC 200 to counteract the impact force and prevent the CDC 200 from generating shocks in response to the impact force. Particular methods for generating and disposing the resisting forces are detailed as follows.

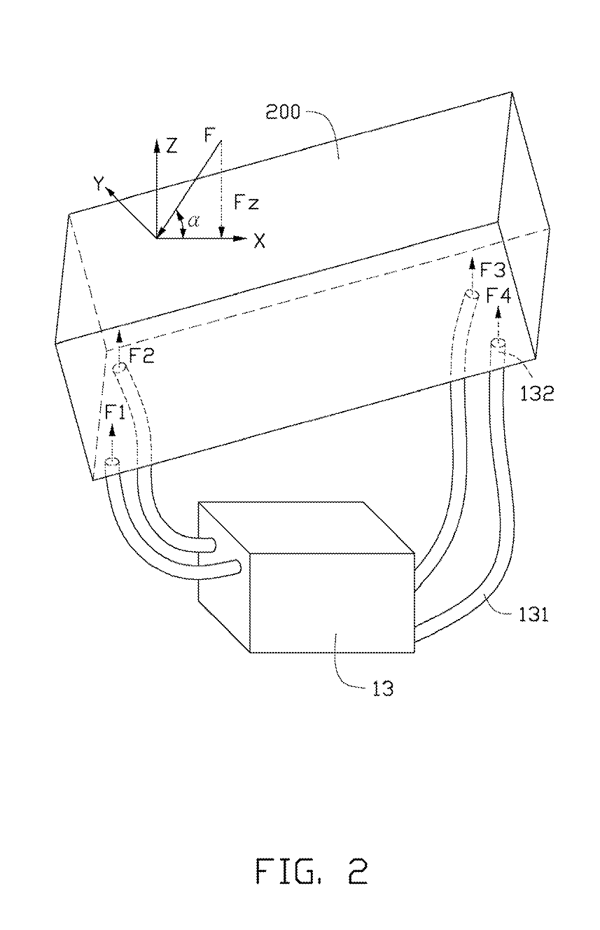

Also referring to FIG. 2, the shockproof module 13 can be an air compressor or a hydraulic compressor. The shockproof module 13 includes a plurality of pressure pipes 131. Pressure medium, such as water, oil or air, is filled in the pressure pipes 131. The shockproof module 13 can compress the medium (e.g., by common pistons of the shockproof module 13 or other devices) to generate predetermined pressures in each of the pressure pipes 131. Each of the pressure pipes 131 has a distal end 132 mounted on an outer surface of the CDC 200, such that the pressures generated in the pressure pipes 131 can be transmitted (either individually or collectively) to the CDC 200 via the distal ends 132 and counteract impact forces which may cause shocks of the CDC 200.

In use, CDCs are generally fixed along horizontal directions (i.e., fixed along both an X-axis and a Y-axis). Therefore, almost all shocks of the CDCs are caused by vertical impact forces (i.e., impact forces along a Z-axis). Accordingly, in the present embodiment, the distal ends of all of the pressure pipes 131 are mounted on a bottom surface of the CDC 200, and thus the shockproof device 100 is dedicated to counteract vertical impact forces. That is, when the CDC 200 encounters an impact force F, the shockproof device 100 only needs to counteract a vertical component (i.e., a component along the Z-axis) Fz of the impact force F. If an angle formed between a direction of the impact force F and a horizontal plane (i.e., the plane defined by the X-axis and the Y-axis) is α, the vertical component Fz can be described by this formula:

Fz=Fsin α

In order to prevent the CDC 200 from generating a shock in response to Fz, the shockproof module 13 should generate a resisting force Fz′ to counteract Fz. It is readily appreciated that Fz′ should have a same value as Fz, and a direction of Fz′ is reverse to a direction of Fz. That is, Fz′ can be described by this formula:

Fz′=−Fz

The data processing module 12 can detect Fz using the impact detection module 11 and determine Fz′ according to Fz. When Fz′ is determined, the data process generates a control signal configured for controlling the shockproof module 13 to generate Fz′. In the present embodiment, the control signal is configured to control the plurality of pressure pipes 131 to respectively generate components F1, F2, F3, . . . Fn of Fz′. The components F1, F2, F3 . . . , Fn are respectively transmitted to predetermined positions of the bottom surface of the CDC 200, and cooperatively form Fz′ to counteract Fz and prevent the CDC 200 from generating a shock in response to Fz. In this embodiment, the components F1, F2, F3, . . . Fn are all substantially vertical forces. The data processing module 12 can make strengths of all of the components F1, F2, F3, . . . Fn to be equal to each other using the control signal, and can also make the components F1, F2, F3, . . . Fn to have different predetermined strengths using the control signal. In other embodiments, the components F1, F2, F3, . . . Fn can also have non-vertical (i.e., being oblique to the Z-axis) directions, and the data processing module 12 can determine strengths and directions of the components F1, F2, F3, . . . Fn using the control signal.

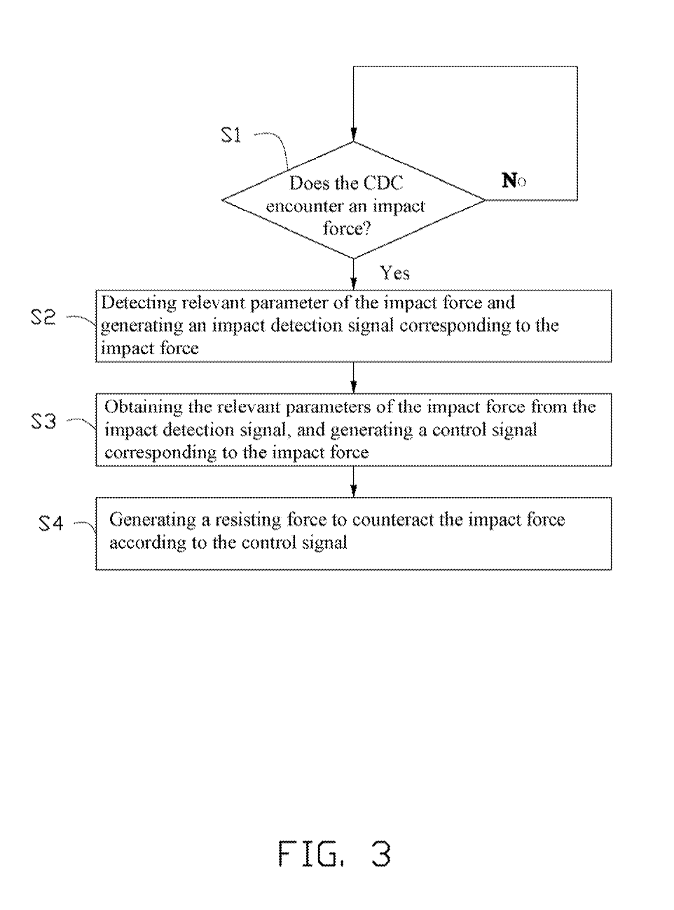

FIG. 3 shows a method for using the shockproof device 100, according to an exemplary embodiment. The method includes steps as the follows. Additionally, the method can also include more steps, some of these steps can be deleted, and an order of these steps can be changed.

First, the impact detection module 11 detects movements of the CDC 200 and thereby further detects whether the CDC 200 encounters impact forces, as detailed above (Step S1). If the CDC 200 encounters an impact force, the impact detection module 11 detects the above-described relevant parameters of the impact force, and generates an impact detection signal corresponding to the impact force (i.e., comprising data of the relevant parameters of the impact force) and transmits the impact detection signal to the data processing module 12 (Step S2).

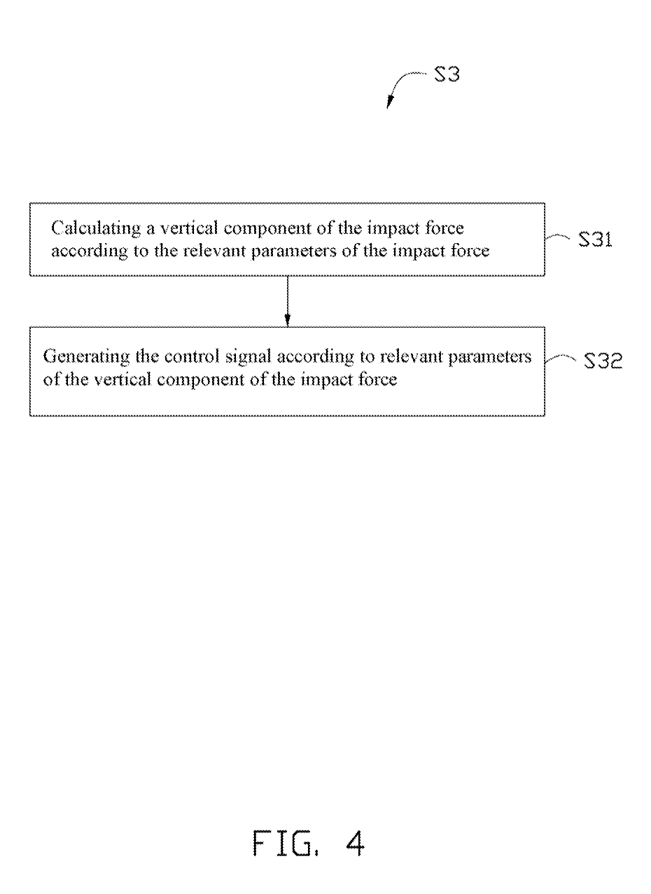

When the data processing module 12 receives the impact detection signal, the data processing module 12 obtains the relevant parameters of the impact force from the impact detection signal, and generates an above-described control signal corresponding to the impact force and sends the control signal to the shockproof module 13 (Step S3). In particular, also referring to FIG. 4, this step includes these sub-steps as follows: the data processing module 12 calculates a vertical component of the impact force according to the above-described method (Sub-step S31); and thus generates the control signal according to relevant parameters of the vertical component of the impact force (Sub-step S32). The control signal can control the shockproof module 13 to generate components of a resisting force corresponding to the vertical component of the impact force in the plurality of pressure pipes 131 respectively, according to the above-described method.

Upon receiving the control signal, the shockproof module 13 generates the components of the resisting force corresponding to the impact force in the pressure pipes 131, respectively, according to the above-described method (Step S4.) As detailed above, the control signal can be used to determine relevant parameters, such as strengths and directions, of the components of the resisting force. These components are transmitted to the CDC 200 via the distal ends 132 of the pressure pipes 131, and cooperatively form the resisting forces to counteract the impact force and prevent the CDC 200 from generating shocks in response to the impact force.

In the present disclosure, the shockproof module 13 can be an air compressor or a hydraulic compressor, and therefore the shockproof module 13 can have much higher load-bearing capability than springs used as shockproof devices of CDCs, and can be prevented from resonance in response to outside impact forces. Furthermore, according to the above-described method, the shockproof device 100 can provide more precise resisting force for counteracting outside impact forces than common shockproof devices for CDCs.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A shockproof device for a container data center (CDC), comprising:
an impact detection module received in or attached on the CDC, the impact detection module configured to detect an impact force of the CDC; and
a shockproof module electrically connected to the impact detection module, the shockproof module including a plurality of pressure pipes, and each of the pressure pipes having a distal end mounted on the CDC;
wherein the shockproof module generates a predetermined pressure using each of the pressure pipes according to the impact force; and
wherein the pressure is transmitted to the distal ends of the pressure pipes and forms a resisting force to counteract the impact force.

2. The shockproof device as claimed in claim 1, wherein the distal ends of the pressure pipes mounted on the CDC are all mounted on a bottom surface of the CDC.

3. The shockproof device as claimed in claim 2, wherein the CDC is fixed along a horizontal direction, and the pressure generated by the pressure pipes is along a vertical direction.

4. The shockproof device as claimed in claim 3, wherein the pressure pipes respectively generate vertical components of the pressure.

5. The shockproof device as claimed in claim 1, wherein the shockproof module is an air compressor or a hydraulic compressor.

6. The shockproof device as claimed in claim 1, wherein the impact detection module is a gyroscope and detects the impact force of the CDC according to movement of the CDC.

7. The shockproof device as claimed in claim 1, further comprising a data processing module that receives an electronic signal indicative of the impact force from the impact detection module, generates a control signal corresponding to the impact force, and sends the control signal to the shockproof module.

8. A method for protecting a container data center (CDC) from impact forces, comprising:
using an impact detection module received in or attached on the CDC to detect an impact force of the CDC;
detecting relevant parameters of the impact force and generating an impact detection signal that includes data of the relevant parameters of the impact force;
generating a control signal corresponding to the impact force based on the relevant parameters of the impact force; and
using a shockproof module that includes a plurality of pressure pipes to generate a predetermined pressure using each of the pressure pipes according to the control signal, and transmitting the pressure to the CDC to counteract the impact force.

9. The method as claimed in claim 8, wherein the step of generating the control signal corresponding to the impact force based on the relevant parameters of the impact force includes:
calculating a vertical component of the impact force; and
generating the control signal according to relevant parameters of the vertical component of the impact force.

10. The method as claimed in claim 9, wherein the pressure generated by the pressure pipes of the shockproof module is along a vertical direction.

11. The method as claimed in claim 10, wherein the pressure pipes respectively generate vertical components of the pressure.

12. The method as claimed in claim 11, further comprising fixing the CDC along horizontal directions.

13. The method as claimed in claim 8, wherein the impact detection module is a gyroscope and detects the impact force of the CDC according to movement of the CDC.
